(19) United States
(12) Patent Application Publication
(10) Pub. No.: US 2005/0212682 A1
(43) Pub. Date: Sep. 29, 2005

(54) Wedge lite

(76) Inventor: James T. Petriello, Valley Cottage, NY (US)

Correspondence Address: James T. Petriello, 299 Christian Herald Rd,, Valley Cottage, NY, 10989, US

(21) Appl. No.: 10/811,381

(22) Filed: Mar. 29, 2004

(51) Int. Cl. G08B 3/00

(52) U.S. Cl. 340/691.1; 340/384.1

(57) ABSTRACT

The invention consists of a plastic door wedge or chock, the body of which is constructed of two pieces hinged at the bottom, so when the invention is inserted under a door to a room the body compresses together allowing an electrical circuit to be completed. Once the circuit has been completed a flashing strobe activates. This flashing strobe can provide a visual cue as to the direction and distance of the door, further providing the user with a quick exit. This visual cue is especially useful to emergency personnel in a dark or smoke-filled environment, such as a building fire or blackout situation. Upon completion of the operation by the emergency personnel, the invention need merely be removed from under the door, and it will expand form the force of the spring inside and open the electrical circuit deactivating the invention. Although an exemplary embodiment of the present invention has been shown and described, it should be apparent to those having ordinary skill in the art that various changes, modifications, or alterations to the invention as described herein may be made, none of which change the spirit of the present invention. All changes, modifications, or alterations should therefore be seen as within the scope of the invention.

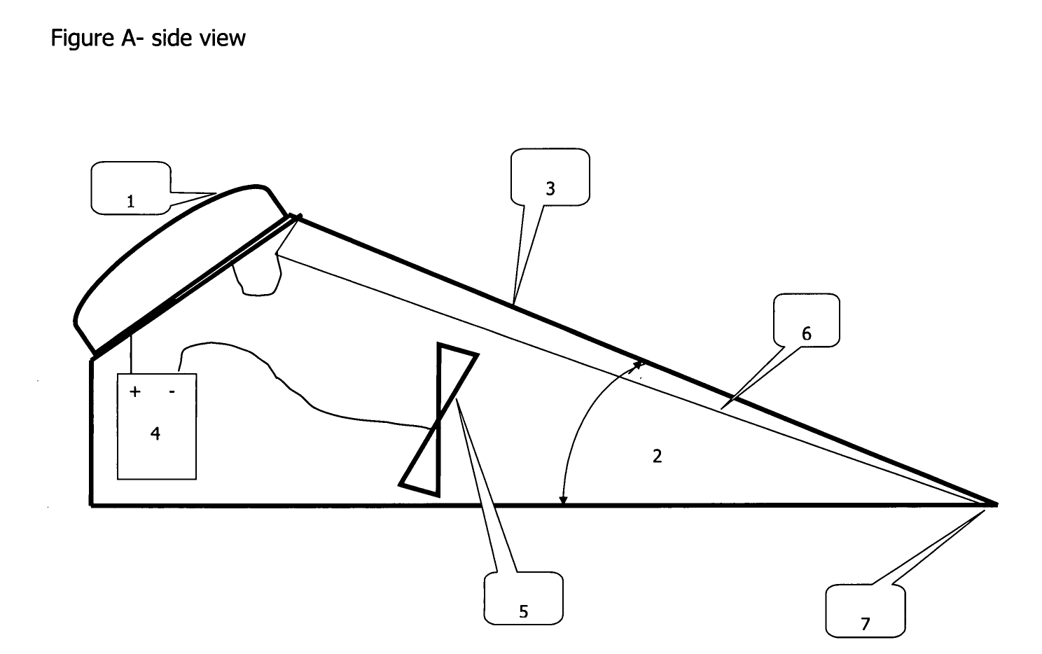

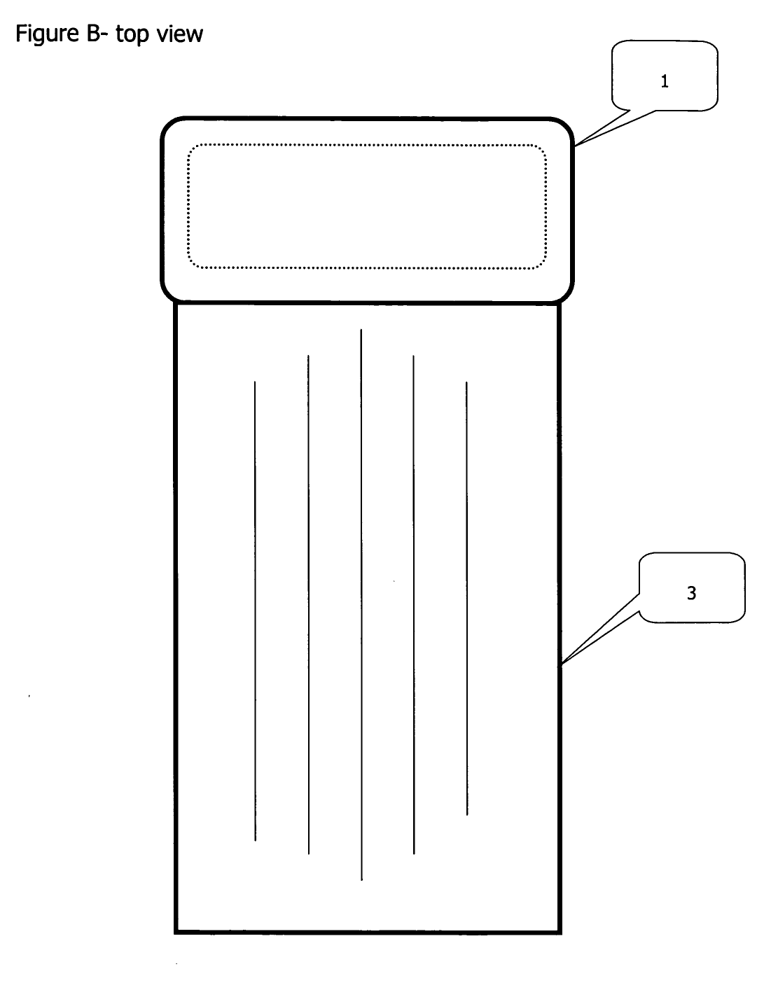

### CROSS-REFERENCE TO RELATED APPLICATIONS

| | | | |
|---|---|---|---|
| 828834 | Aug/1906 | Bell | 340/546 |
| 3805322 | April/1974 | Serrano | 16/82 |
| 4890092 | Dec/1989 | Grimm | 340/546 |
| 5008648 | April/1991 | Conemac | 340/546 |
| 5465460 | Nov/1995 | Cantone | 340/546 |

### FEDERALLY SPONSORED RESEARCH & DEVELOPMENT

“Not applicable”

### SEQUENCE LISTING

“Not applicable”

### BACKGROUND OF THE INVENTION

### Field of the Invention

The invention relates generally to firefighting operations and more specifically to “search and rescue” operations.

### SUMMARY OF THE INVENTION

The first intention of the invention is to provide emergency personnel, primarily, but not limited to, firefighters, a fast means of finding an exit during firefighting operations.

The second intention of the invention is to hold open the primary means of egress, i.e. door, whether it is an exterior door or interior door of a building.

The third intention of the invention is to provide a means of visually identifying the route of egress, quickly and decisively by using a high powered strobe that repeatedly flashes.

The fourth intention of the invention is to automatically be activated when “wedged” under an open door, thereby allowing the emergency personnel the freedom to focus on other tasks.

### BRIEF DESCRIPTION OF THE VIEWS OF THE DRAWINGS

Figure A is the side (internal) of the invention.

Item 1 is the strobe unit.

Item 2 is the body of the unit.

Item 3 is the hinged cover of the unit.

Item 4 is the battery (power supply).

Item 5 is a compressible spring.

Item 6 is a metal plate connected to the underside of the hinged cover.

Item 7 is the hinge for the cover.

Figure B is the top view of the invention.

Item 1 is the strobe unit.

Item 3 is the hinged cover of the unit.

### DETAILED DESCRIPTION OF THE INVENTION

Emergency personnel, particularly firefighters, face an extremely dangerous and difficult task during the search and rescue phase of a firefighting operation. While on their hands and knees a firefighter must often search a smoke-filled room with extremely limited visibility. During this operation a firefighter can become disoriented and lose his or her bearings in relation to the exit or door that he or she just entered. This invention provides a quick and easy way of regaining those bearings, and provides a visual beacon should a quick exit become necessary. Referring to the drawings, Item 2 is the body of the invention that contains the internal spring switch, battery and wiring.

A high powered strobe (1) flashes upwards and outwards when activated. Activation is simple and achieved by inserting the invention under the bottom of an open door, this action causes the hinged cover (3) and metal plate (6) to be compressed downward until the metal plate (6) contacts the compressible spring (5), which in turn completes an electrical circuit and activating the strobe (1). Power is supplied by an onboard battery (4). Simply removing the invention from the underside of the door allows the hinged cover (3) and metal plate (6) to return to their original position, thus deactivating the invention.

1. By combining a simple door “wedge” or “chock” with a battery operated high powered strobe the invention provides:
a) Means for providing a door holding device that will prevent a building door from closing;
b) Means for providing a flashing strobe to provide a visual cue as to the location and distance of said door;
c) Means of activating the strobe by simply inserting or “wedging” the invention under a door in a building;
d) Means of deactivating the strobe by simply removing the invention from under the door.
